(19) United States
(12) Patent Application Publication
(10) Pub. No.: US 2024/0332924 A1
(43) Pub. Date: Oct. 3, 2024

(54) TEMPLATE APPARATUS FOR ELECTRICAL BOX CUTOUTS

(71) Applicant: Juan Bernabe Rodriguez, San Juan Capistrano, CA (US)

(72) Inventor: Juan Bernabe Rodriguez, San Juan Capistrano, CA (US)

(21) Appl. No.: 18/112,568

(22) Filed: Feb. 22, 2023

(51) Int. Cl. H02G 1/00

(52) U.S. Cl. CPC H02G 1/00

(57) ABSTRACT

A template apparatus for marking a location for an electrical box on a wall includes a panel that is elongated from a first end to a second end of the panel. The panel has an aperture extending therethrough. A frame is coupled to a front side of the panel. The frame has a first mount member and a second mount member which are laterally spaced from each other with respect to the panel across the aperture of the panel. An outline defining member for forming a template outline is interchangeably positionable in one use position of a plurality of use positions relative to the frame. The template outline is formed by a peripheral edge of the aperture and the outline defining member when the outline defining member is positioned in one of the plurality of use positions.

### BACKGROUND OF THE INVENTION

### (1) Field of the Invention

The disclosure relates to template apparatuses and more particularly pertains to a new template apparatus for marking a location for an electrical box on a wall.

### (2) Description of Related Art Including Information Disclosed Under 37 CFR 1.97 and 1.98

The prior art discloses myriad template apparatuses which each include an aperture sized to mark locations for holes for receiving an electrical box. Several of these apparatuses include a member for engaging wall stud or other structural member to position the aperture relative to the structural member. Some template apparatuses in the prior art have multiple apertures of different sizes for marking locations for differently sized electrical boxes. U.S. Pat. No. 4,696,113 discloses a template apparatus with moving frame elements that adjust to change the size of the aperture for differently sized electrical boxes. However, the prior art does not disclose a template apparatus which has a size-adjusting member that is securable in several discrete positions with respect to the aperture to form a template outline of different discrete sizes. Such a device is desirable as an alternative to other structures that provide apertures of different or varying sizes.

### BRIEF SUMMARY OF THE INVENTION

An embodiment of the disclosure meets the needs presented above by generally comprising a panel that is elongated from a first end to a second end of the panel. The panel has an aperture extending therethrough. A frame is coupled to a front side of the panel. The frame has a first mount member and a second mount member which are laterally spaced from each other with respect to the panel across the aperture of the panel. An outline defining member for forming a template outline is interchangeably positionable in one use position of a plurality of use positions relative to the frame. The template outline is formed by a peripheral edge of the aperture and the outline defining member when the outline defining member is positioned in one of the plurality of use positions.

Another embodiment of the disclosure generally comprises a method of marking a location for an electrical box on a wall. The method comprises positioning a panel of a template apparatus against the wall such that a peripheral edge of an aperture extending through the panel is aligned with an outer surface of the wall. An outline defining member of the template apparatus is positioned in a use position in which a template outline is formed by the peripheral edge of the aperture and the outline defining member. The template outline formed is complementary in size and shape to a perimeter of the electrical box. The outline defining member is secured in the use position, and a lower edge of the template outline is oriented horizontally. The template apparatus comprises a level indicator for indicating when the lower edge is oriented horizontally. The template outline is traced with a marking device to mark the wall to indicate a boundary of a cutout to be made for the electrical box.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a template apparatus according to an embodiment of the disclosure.

FIG. 2 is a perspective view of an embodiment of the disclosure.

FIG. 3 is a front view of an embodiment of the disclosure.

FIG. 4 is a side in-use view of an embodiment of the disclosure.

FIG. 5 is a back view of an embodiment of the disclosure.

FIG. 6 is a front in-use view of an embodiment of the disclosure.

FIG. 7 is a front in-use view of an embodiment of the disclosure.

FIG. 8 is a front in-use view of an embodiment of the disclosure.

### DETAILED DESCRIPTION OF THE INVENTION

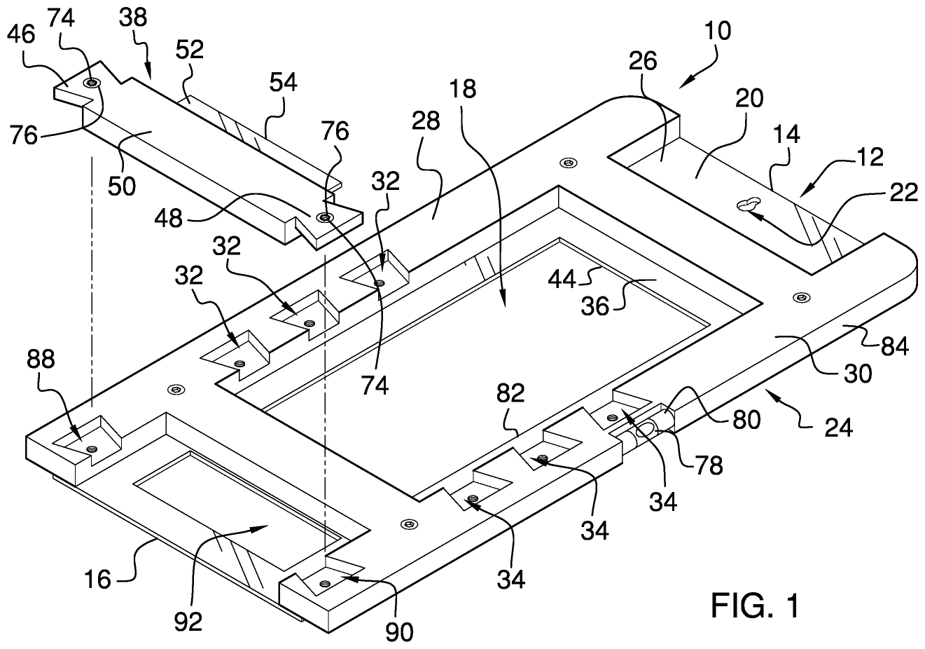

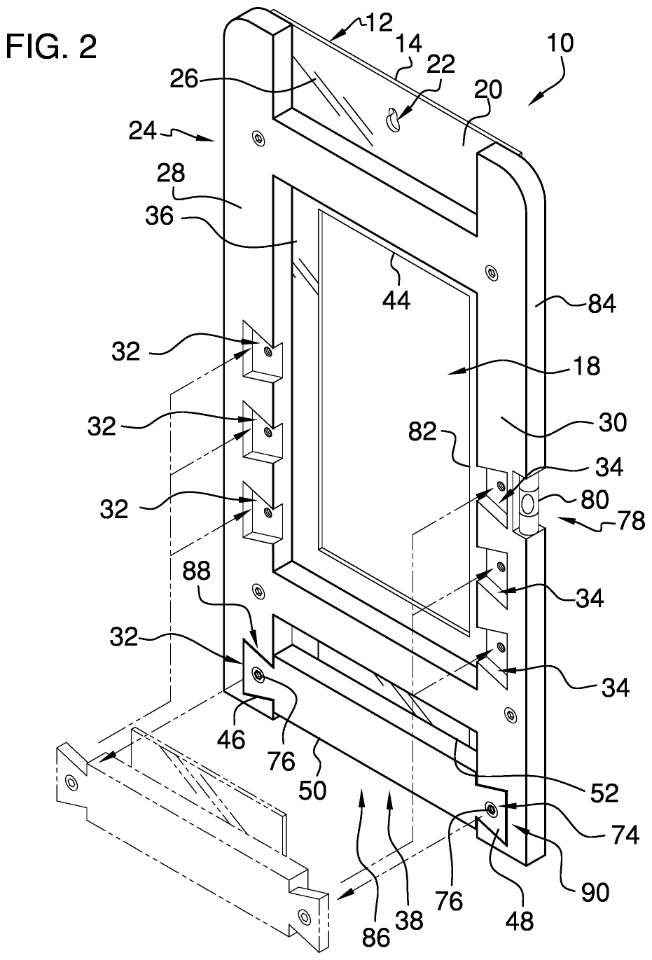

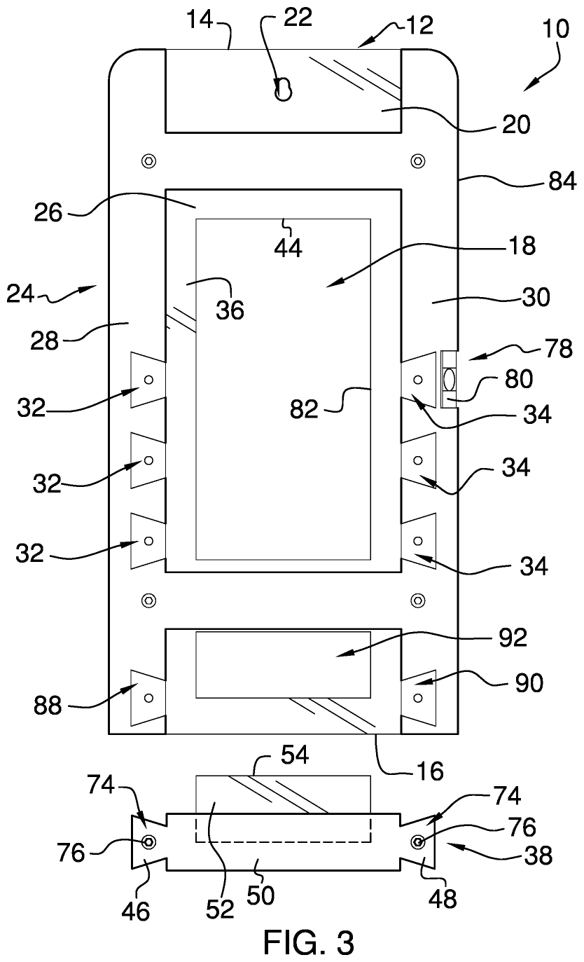

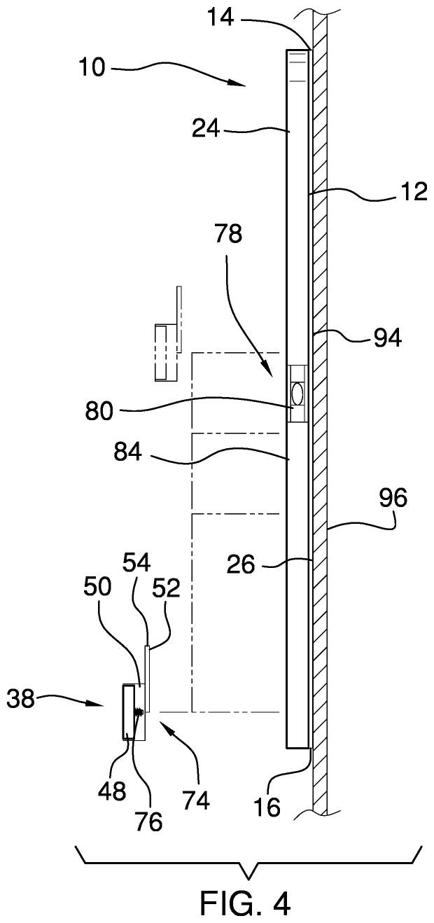

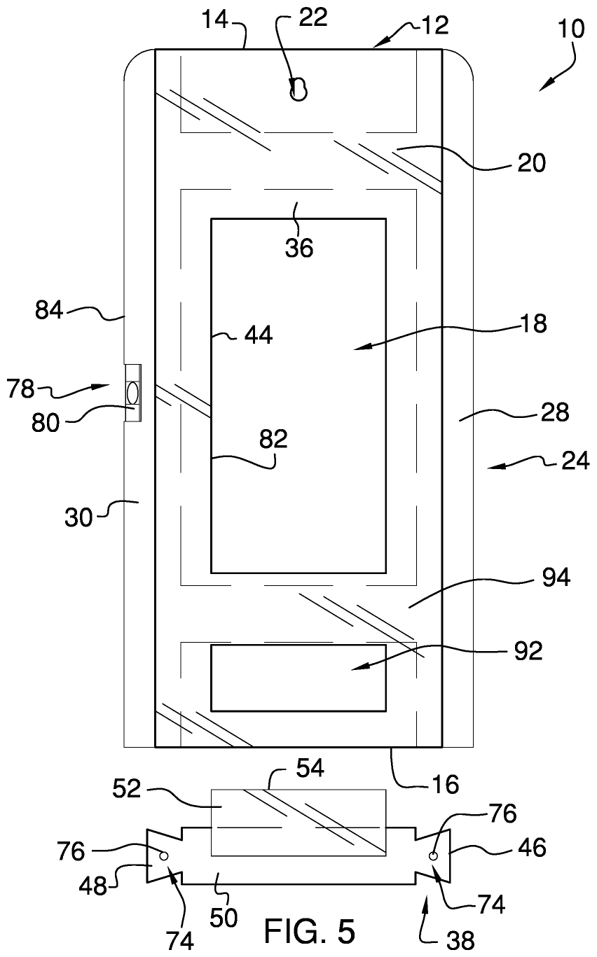

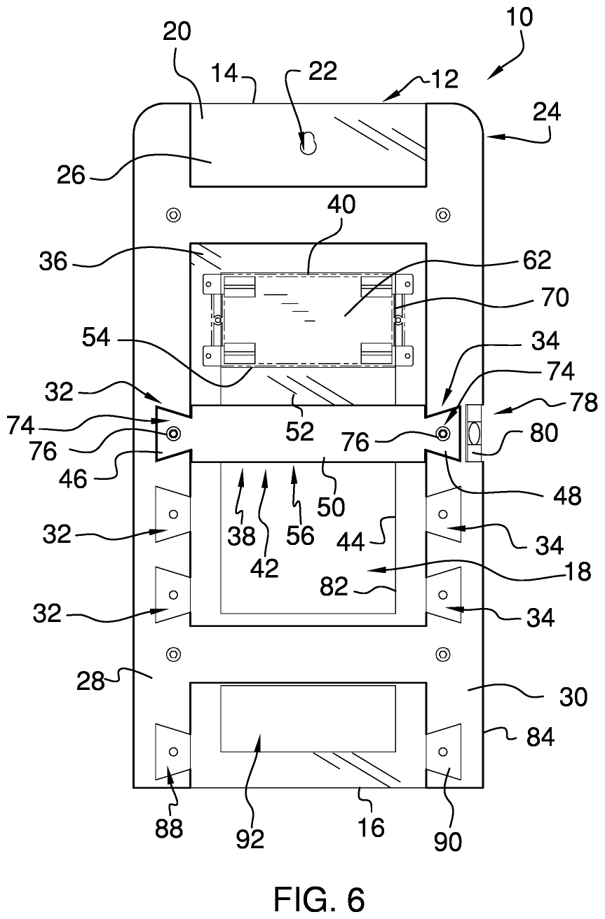

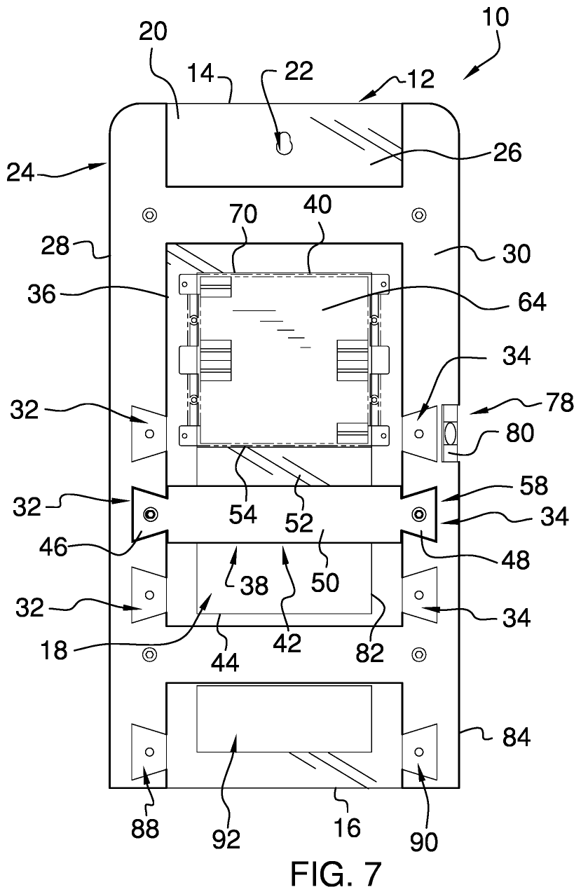

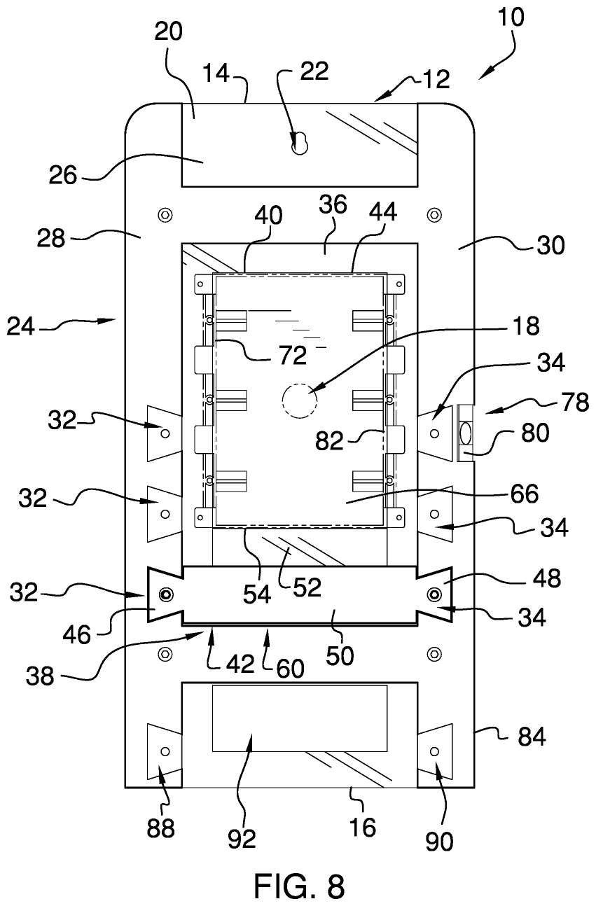

With reference now to the drawings, and in particular to FIGS. 1 through 8 thereof, a new template apparatus embodying the principles and concepts of an embodiment of the disclosure and generally designated by the reference numeral 10 will be described.

As best illustrated in FIGS. 1 through 8, the template apparatus 10 generally comprises a panel 12 which is elongated from a first end 14 to a second end 16 of the panel 12. The panel 12 has an aperture 18 extending therethrough and is comprised of a translucent material 20 such that objects are viewable through the panel 12. The translucent material 20 is acrylic, but may be glass, polycarbonate, or the like. The panel 12 also has an opening 22 extending therethrough adjacent to the first end 14 which is shaped for hanging the panel 12 on a nail, threaded fastener, hook, or the like via the opening 22.

A frame 24 is coupled to a front side 26 of the panel 12. The frame 24 has a first mount member 28 and a second mount member 30 which are laterally spaced from each other with respect to the panel 12 across the aperture 18 of the panel 12. The first mount member 28 has a plurality of first recesses 32 extending therein toward the panel 12, and the second mount member 30 has a plurality of second recesses 34 extending therein toward the panel 12. Each of the first recesses 32 is laterally aligned with one of the second recesses 34. The aperture 18 of the panel 12 is spaced inwardly from the frame 24 to define a boundary region 36 of the panel 12 surrounding the aperture 18.

An outline defining member 38 for forming a template outline 40 is interchangeably positionable in one use position 42 of a plurality of use positions 42 relative to the frame 24. The template outline 40 is formed by a peripheral edge 44 of the aperture 18 and the outline defining member 38 when the outline defining member 38 is positioned in one of the plurality of use positions 42. Each use position 42 corresponds to one of the first recesses 32 of the plurality of first recesses 32 and to one of the second recesses 34 of the plurality of second recesses 34. The outline defining member 38 comprises a first insertion portion 46, a second insertion portion 48, a central portion 50, and an outline portion 52. The first insertion portion 46 is complementary in size and shape to each first recess 32 of the plurality of first recesses 32, and the second insertion portion 48 is complementary in size and shape to each second recess 34 of the plurality of second recesses 34. The central portion 50 is coupled to and extends between the first insertion portion 46 and the second insertion portion 48.

The outline portion 52 is coupled to the central portion 50 and is arranged to extend away from the central portion 50 toward the first end 14 of the panel 12 when the outline defining member 38 is positioned in one of the plurality of use positions 42. The template outline 40 is formed by a peripheral edge 44 of the aperture 18 and a distal edge 54 of the outline portion 52 with respect to the central portion 50 when the outline defining member 38 is positioned in one of the plurality of use positions 42. The outline portion 52 is planar and aligns with the panel 12 when the outline defining member 38 is positioned in one of the plurality of use positions 42. The outline portion 52 also comprises the translucent material 20 so that a user can view through the template apparatus 10 around the template outline 40.

The plurality of use positions 42 comprises a first use position 56 in which the template outline 40 is complementary in size and shape to a perimeter 68 of a single gang electrical box 62, a second use position 58 in which the template outline 40 is complementary in size and shape to a perimeter 70 of a two gang electrical box 64, and a third use position 60 in which the template outline 40 is complementary in size and shape to a perimeter 72 of a three gang electrical box 66. When the outline defining member 38 is positioned in the first use position 56, the template outline 40 has a width extending longitudinally with respect to the panel 12 of between 2.0 inches and 2.5 inches. When the outline defining member 38 is positioned in the second use position 58, the width of the template outline 40 is between 3.75 inches and 4.25 inches. When the outline defining member 38 is positioned in the third use position 60, the width of the template outline 40 is between 5.25 inches and 5.75 inches. When the outline defining member 38 is positioned in any of the first, second, and third positions, the template outline 40 has a height extending laterally with respect to the panel 12 of between 3.75 inches and 4.25 inches.

A connector 74 is attachable to the outline defining member 38 and the frame 24 to releasably secure the outline defining member 38 to the frame 24 in each of the plurality of use positions 42. The connector 74 comprises a pair of threaded fasteners 76, each of which is insertable through the outline defining member 38 and into one of the first mount member 28 and the second mount member 30 when the outline defining member 38 is positioned in any use position 42 of the plurality of use positions 42. A level indicator 78 is coupled to the frame 24 and is calibrated to indicate when a lower edge 82 of the template outline 40 is horizontal. The level indicator 78 is positioned between the aperture 18 and an outer edge 84 of the second mount member 30 with respect to the panel 12 and comprises a bubble level 80.

The outline defining member 38 is also positionable in a storage position 86 adjacent to the second end 16 of the panel 12. The first mount member 28 has a first notch 88 extending therein toward the panel 12 for receiving the first insertion portion 46 when the outline defining member 38 is positioned in the storage position 86, and the second mount member 30 has a second notch 90 extending therein toward the panel 12 for receiving the second insertion portion 48 when the outline defining member 38 is positioned in the storage position 86. The panel 12 has a storage slot 92 for receiving the outline portion 52 of the outline defining member 38 when the outline defining member 38 is positioned in the storage position 86. Each threaded fastener 76 is insertable through the outline defining member 38 and into one of the first mount member 28 and the second mount member 30 when the outline defining member 38 is positioned in the storage position 86.

In use, a rear side 94 of the panel 12 is positioned against a wall 96. The outline defining member 38 is positioned in a selected one of the use positions 42 and secured to the frame 24 in the selected use position 42 via the connector 74. The user positions the panel 12 such that the lower edge 82 of the template outline 40 is oriented horizontally as indicated by the level indicator 78. The user then traces the template outline 40 with a marking apparatus to indicate a boundary of a cutout on the wall 96 for the electrical box. The marking apparatus may, for example, be a pen, marker, pencil, scribe, knife, or the like.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A template apparatus for marking a location for an electrical box on a wall, the template apparatus comprising:
a panel being elongated from a first end to a second end of the panel, the panel having an aperture extending therethrough;
a frame being coupled to a front side of the panel, the frame having a first mount member and a second mount member being laterally spaced from each other with respect to the panel across the aperture of the panel; and
an outline defining member for forming a template outline being interchangeably positionable in one use position of a plurality of use positions relative to the frame, the template outline being formed by a peripheral edge of the aperture and the outline defining member when the outline defining member is positioned in one of the plurality of use positions.

2. The apparatus of claim 1, wherein the aperture of the panel is spaced inwardly from the frame to define a boundary region of the panel surrounding the aperture, the panel being comprised of a translucent material.

3. The apparatus of claim 2, wherein the translucent material is acrylic.

4. The apparatus of claim 1, wherein the first mount member has a plurality of first recesses extending therein toward the panel, the second mount member having a plurality of second recesses extending therein toward the panel, each of the first recesses being laterally aligned with one of the second recesses, each use position corresponding to one of the first recesses of the plurality of first recesses and to one of the second recesses of the plurality of second recesses, the outline defining member comprising:
a first insertion portion being complementary in size and shape to each first recess of the plurality of first recesses;
a second insertion portion being complementary in size and shape to each second recess of the plurality of second recesses; and
a central portion being coupled to and extending between the first insertion portion and the second insertion portion.

5. The apparatus of claim 4, wherein the outline defining member further comprises an outline portion being coupled to the central portion, the outline portion extending away from the central portion toward the first end of the panel when the outline defining member is positioned in one of the plurality of use positions, the template outline being formed by a peripheral edge of the aperture and a distal edge of the outline portion with respect to the central portion when the outline defining member is positioned in one of the plurality of use positions.

6. The apparatus of claim 5, wherein the outline portion is planar and aligning with the panel when the outline defining member is positioned in one of the plurality of use positions.

7. The apparatus of claim 5, wherein the aperture of the panel is spaced inwardly from the frame to define a boundary region of the panel surrounding the aperture, the panel being comprised of a translucent material, the outline portion of the outline defining member comprising the translucent material.

8. The apparatus of claim 7, wherein the translucent material is acrylic.

9. The apparatus of claim 1, wherein the plurality of use positions includes a first use position, the template outline being complementary in size and shape to a perimeter of a single gang electrical box when the outline defining member is positioned in the first use position.

10. The apparatus of claim 9, wherein the plurality of use positions includes a second use position, the template outline being complementary in size and shape to a perimeter of a two gang electrical box when the outline defining member is positioned in the second use position.

11. The apparatus of claim 10, wherein the plurality of use positions includes a third use position, the template outline being complementary in size and shape to a perimeter of a three gang electrical box when the outline defining member is positioned in the third use position.

12. The apparatus of claim 11, wherein:
the template outline has a width extending longitudinally with respect to the panel of between 2.0 inches and 2.5 inches when the outline defining member is in the first use position, the template outline a height extending laterally with respect to the panel of between 3.75 inches and 4.25 inches when the outlet defining member is in the first use position;
the width of the template outline is between 3.75 inches and 4.25 inches when the outlet defining member is in the second use position, the height of the template outline being between 3.75 inches and 4.25 inches when the outlet defining member is in the second use position; and
the width of the template outline is between 5.25 inches and 5.75 inches when the outlet defining member is in the third use position, the height of the template outline being between 3.75 inches and 4.25 inches when the outlet defining member is in the third use position.

13. The apparatus of claim 1, further comprising a connector being attachable to the outline defining member and the frame to releasably secure the outline defining member to the frame in each of the plurality of use positions.

14. The apparatus of claim 13, wherein the connector comprises a pair of threaded fasteners, each threaded fastener being insertable through the outline defining member and into one of the first mount member and the second mount member when the outline defining member is positioned in any use position of the plurality of use positions.

15. The apparatus of claim 1, further comprising a level indicator being coupled to the frame and being calibrated to indicate when a lower edge of the template outline is horizontal, the level indicator being positioned between the aperture and an outer edge of the second mount member with respect to the panel, the level indicator comprising a bubble level.

16. The apparatus of claim 5, the outline defining member being positionable in a storage position adjacent to the second end of the panel, the first mount member having a first notch extending therein toward the panel for receiving the first insertion portion when the outline defining member is positioned in the storage position, the second mount member having a second notch extending therein toward the panel for receiving the second insertion portion when the outline defining member is positioned in the storage position, the panel having a storage slot for receiving the outline portion of the outline defining member when the outline defining member is positioned in the storage position, each threaded fastener being insertable through the outline defining member and into one of the first mount member and the second mount member when the outline defining member is positioned in the storage position.

17. A template apparatus for marking a location for an electrical box on a wall, the template apparatus comprising:
a panel being elongated from a first end to a second end of the panel, the panel having an aperture extending therethrough, the panel being comprised of a translucent material, the translucent material being acrylic;
a frame being coupled to a front side of the panel, the frame having a first mount member and a second mount member being laterally spaced from each other with respect to the panel across the aperture of the panel, the first mount member having a plurality of first recesses extending therein toward the panel, the second mount member having a plurality of second recesses extending therein toward the panel, each of the first recesses being laterally aligned with one of the second recesses, the aperture of the panel being spaced inwardly from the frame to define a boundary region of the panel surrounding the aperture;
an outline defining member for forming a template outline being interchangeably positionable in one use position of a plurality of use positions relative to the frame, the template outline being formed by a peripheral edge of the aperture and the outline defining member when the outline defining member is positioned in one of the plurality of use positions, each use position corresponding to one of the first recesses of the plurality of first recesses and to one of the second recesses of the plurality of second recesses, the outline defining member comprising:
a first insertion portion being complementary in size and shape to each first recess of the plurality of first recesses;
a second insertion portion being complementary in size and shape to each second recess of the plurality of second recesses;
a central portion being coupled to and extending between the first insertion portion and the second insertion portion; and
an outline portion being coupled to the central portion, the outline portion extending away from the central portion toward the first end of the panel when the outline defining member is positioned in one of the plurality of use positions, the template outline being formed by a peripheral edge of the aperture and a distal edge of the outline portion with respect to the central portion when the outline defining member is positioned in one of the plurality of use positions, the outline portion being planar and aligning with the panel when the outline defining member is positioned in one of the plurality of use positions, the outline portion comprising the translucent material;
the plurality of use positions comprising:
a first use position, the template outline being complementary in size and shape to a perimeter of a single gang electrical box when the outline defining member is positioned in the first use position, the template outline having a width extending longitudinally with respect to the panel of between 2.0 inches and 2.5 inches when the outline defining member is in the first use position, the template outline a height extending laterally with respect to the panel of between 3.75 inches and 4.25 inches when the outlet defining member is in the first use position;
a second use position, the template outline being complementary in size and shape to a perimeter of a two gang electrical box when the outline defining member is positioned in the second use position, the width of the template outline being between 3.75 inches and 4.25 inches when the outlet defining member is in the second use position, the height of the template outline being between 3.75 inches and 4.25 inches when the outlet defining member is in the second use position; and
a third use position, the template outline being complementary in size and shape to a perimeter of a three gang electrical box when the outline defining member is positioned in the third use position, the width of the template outline being between 5.25 inches and 5.75 inches when the outlet defining member is in the third use position, the height of the template outline being between 3.75 inches and 4.25 inches when the outlet defining member is in the third use position;
a connector being attachable to the outline defining member and the frame to releasably secure the outline defining member to the frame in each of the plurality of use positions, the connector comprising a pair of threaded fasteners, each threaded fastener being insertable through the outline defining member and into one of the first mount member and the second mount member when the outline defining member is positioned in any use position of the plurality of use positions;
a level indicator being coupled to the frame and being calibrated to indicate when a lower edge of the template outline is horizontal, the level indicator being positioned between the aperture and an outer edge of the second mount member with respect to the panel, the level indicator comprising a bubble level; and
the outline defining member being positionable in a storage position adjacent to the second end of the panel, the first mount member having a first notch extending therein toward the panel for receiving the first insertion portion when the outline defining member is positioned in the storage position, the second mount member having a second notch extending therein toward the panel for receiving the second insertion portion when the outline defining member is positioned in the storage position, the panel having a storage slot for receiving the outline portion of the outline defining member when the outline defining member is positioned in the storage position, each threaded fastener being insertable through the outline defining member and into one of the first mount member and the second mount member when the outline defining member is positioned in the storage position.

19. A method of marking a location for an electrical box on a wall, the method comprising:
positioning a panel of a template apparatus against the wall such that a peripheral edge of an aperture extending through the panel is aligned with an outer surface of the wall;
positioning an outline defining member of the template apparatus in a use position wherein a template outline is formed by the peripheral edge of the aperture and the outline defining member, wherein the template outline is complementary in size and shape to a perimeter of the electrical box;
securing the outline defining member in the use position;
orienting a lower edge of the template outline horizontally, wherein the template apparatus comprises a level indicator arranged to indicate when the lower edge is oriented horizontally; and
tracing the template outline with a marking device to mark the wall to indicate a boundary of a cutout to be made for the electrical box.
